(19) United States
(12) Patent Application Publication
(10) Pub. No.: US 2010/0002215 A1
(43) Pub. Date: Jan. 7, 2010

(54) IMAGING OPTICAL SYSTEM, EXPOSURE APPARATUS, AND DEVICE MANUFACTURING METHOD

(75) Inventor: Koichi Sentoku, Kawachi-gun (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/496,544

(22) Filed: Jul. 1, 2009

(30) Foreign Application Priority Data
Jul. 4, 2008 (JP) 2008-175916

(51) Int. Cl. G03B 27/52

(52) U.S. Cl. 355/55

(57) ABSTRACT

An optical system is used in a detection unit of an exposure apparatus that projects an original pattern by exposure onto a substrate via a projection optical system. The detection unit detects a position of the substrate in the optical axis direction of the projection optical system. The optical system includes a first imaging optical system configured to form an object image in the measurement region of the substrate by oblique light incidence, and a second imaging optical system configured to focus the object image onto a light receiving unit. The following relationship is satisfied:

(α−1)×(γ−1)>0

where β represents an absolute value of a magnification of the first imaging optical system, α×L₂ represents an image distance, γ/β represents an absolute value of a magnification of the second imaging optical system, L₂ represents an object distance, and α and γ are positive real numbers.

### BACKGROUND OF THE INVENTION

1. Field of the Invention

The present invention relates to an imaging optical system and an exposure apparatus for use in manufacturing semiconductor devices, liquid crystal display devices, thin-film magnetic heads, etc. by lithography.

2. Description of the Related Art

With recent decreases in pattern line width of semiconductor devices, the numerical aperture (NA) of projection lenses of exposure apparatuses has been increased, the wavelength of exposure light has been shortened, and the screen size has been increased. For these purposes, exposure apparatuses called “steppers” have been used. The steppers project an exposure area onto a wafer in a reduced scale by full exposure. Nowadays, scan-type exposure apparatuses (hereinafter referred to as “scanners”) are being mainly used. In the scanners, an exposure area in the form of a rectangular or arc-shaped slit is used and a reticle and a wafer are relatively scanned at a high speed, thus precisely scanning a large-size screen.

In scanners, the surface shape of a wafer can be aligned with the best exposure image plane in the unit of an exposure slit. Hence, the scanners use a technique of measuring the position of the wafer surface before the exposure slit with a surface-position detecting device of an oblique incident type and correcting the position. This allows the wafer surface to be aligned with the exposure image plane in real time during scanning exposure.

In particular, measurement is performed at a plurality of measurement points in the longitudinal direction of the exposure slit, that is, in a direction orthogonal to so-called scanning direction in order to measure not only the height, but also the tilt of the wafer surface. Methods for measuring the focus and tilt in scanning exposure are proposed in Japanese Patent Laid-Open Nos. 06-260391, 11-238665, 11-238666, 2006-352112, and 2003-059814. Hereinafter, measurement of the position of the wafer surface will be referred to as “focus measurement”.

Light emitted from a light source 800, such as an excimer laser, passes through an illumination system 801 formed by an exposure slit having the shape best suited to exposure, and illuminates a pattern surface provided on a lower surface of a mask or a reticle (hereinafter referred to as a reticle 100). A pattern to be exposed is provided on the pattern surface of the reticle 100. Light from the pattern passes through a projection lens 802, and forms an image near a surface of a wafer 803 serving as an image plane (see FIG. 10).

The reticle 100 is placed on a reticle stage RS that can reciprocate for scanning in one direction (Y-direction).

The wafer 803 is placed on a wafer stage WS that can scan in the X-, Y-, and Z-directions shown in FIG. 10 and that is capable of tilt correction.

By relatively scanning the reticle stage RS and the wafer stage WS at a speed ratio corresponding to the imaging magnification of the pattern, one shot region on the reticle 100 is exposed. After exposure of one shot region is completed, the wafer stage W″ steps to the next shot, and the next shot is exposed by scanning exposure in the direction opposite the previous scanning direction. These operations are called step and scan, and this exposure method is unique to the scanner. By repeating these operations, all shots in the entire wafer 803 are exposed.

During scanning exposure of one shot, plane position information about the surface of the wafer 803 is acquired by focus and tilt detecting systems 833 and 834, and the amount of displacement from the exposure image plane is calculated. Then, the stage is driven in the Z-direction and the tilt direction, so that the surface shape of the wafer 803 in the height direction is aligned in the unit of the exposure slit.

FIG. 11 shows structures of the focus and tilt detecting systems 833 and 834. The focus and tilt detecting systems 833 and 834 are formed by optical height measuring systems. An image of a measurement mark 807 illuminated with illumination light is obliquely projected onto the surface of the wafer 803, exactly, a surface of a resist applied on the wafer 803 via a light emitting optical system 805, and the projected image is focused onto a detection surface of a photoelectric converter 804 via a light receiving optical system 806. The position of an optical image of the measurement mark 807 on the detection surface of the photoelectric converter 804 moves with the movement of the wafer 803 in the Z-direction. By calculating the moving amount of the optical image, the moving amount of the wafer 803 in the Z-direction is detected. In particular, a plurality of light beams (multi-mark image) are caused to be incident on a plurality of measurement points on the wafer 803 and are guided to corresponding sensors, and the tilt of the surface to be exposed is calculated from information about different measured focus positions.

In the exposure apparatus, when the focus position on the wafer surface placed below the projection optical system is measured with an oblique incident type optical system, the optical system needs to be placed in a manner such as to avoid a barrel of the projection optical system or devices near the barrel and such that measuring light is not blocked by the barrel. In recent years, the exposure apparatus has been complicated to enhance the required performance, and it is difficult to ensure a sufficient space near the barrel where the optical system is placed. In particular, since an EUV exposure apparatus using EUV light as exposure light is partly or entirely installed in a vacuum chamber, a measuring system also needs to be installed in the vacuum chamber. The size of the vacuum chamber should be minimized in order to maintain a constant degree of vacuum in the chamber. Reduction of the space for the measuring optical system can contribute to size reduction of the vacuum chamber.

Japanese Patent Laid-Open Nos. 11-238665 and 11-238666 introduce methods relating to placement of a focus measuring optical system near a barrel in an EUV exposure apparatus. Japanese Patent Laid-Open No. 11-238665 introduces a method for increasing the degree of flexibility in placing a focus measuring optical system by removing a part of a barrel in a projection optical system so that the barrel does not block measuring light.

On the other hand, Japanese Patent Laid-Open No. 11-238666 introduces a method for making a focus measuring optical system compact by placing a part of a focus measuring optical system between a plurality of mirrors that constitute a reflective projection optical system. However, none of the publications mention a technique of shortening the total length of the focus measuring optical system in the optical axis direction.

While Japanese Patent Laid-Open Nos. 2006-352112 and 2003-059814 may have introduced focus measuring methods using an oblique incident method, none of the publications mention the technique of shortening the total length of the focus measuring optical system in the optical axis direction.

### SUMMARY OF THE INVENTION

An optical system according to an aspect of the present invention is provided in a detection unit in an exposure apparatus that projects a pattern of an original onto a substrate via a projection optical system. The detection unit detects a position of the substrate in an optical axis direction of the projection optical system. The optical system includes a first imaging optical system configured to form an image of an object in a measurement region of the substrate by oblique light incidence; and a second imaging optical system configured to focus the image onto a light receiving unit. The following relationship is satisfied:

(α−1)×(γ−1)>0

where β represents an absolute value of a magnification of the first imaging optical system, α×L₂ represents an image distance, γ/β represents an absolute value of a magnification of the second imaging optical system, L₂ represents an object distance, and α and γ are positive real numbers.

An optical system according to another aspect of the present invention is provided in a detection unit of an exposure apparatus that projects a pattern of an original onto a substrate via a projection optical system. The detection unit detects a position of a measurement region in an optical axis direction of the projection optical system. The optical system includes a first imaging optical system configured to form an image of an object in the measurement region of the substrate by oblique light incidence; and a second imaging optical system configured to focus the image of the object onto a light receiving unit. The following relationship is satisfied:

(α−1)×(γ−1)>0

where β represents an absolute value of a magnification of the first imaging optical system, α×L₂ represents an image distance, γ/β represents an absolute value of a magnification of the second imaging optical system, L₂ represents an object distance, and α and γ are positive real numbers.

An optical system according to a further aspect of the present invention is provided in a detection unit of an exposure apparatus that projects a pattern of an original onto a substrate via a projection optical system. The detection unit detects a position of a measurement region in an optical axis direction of the projection optical system. The optical system includes two imaging optical systems. An image of an object is formed in the measurement region by causing light to be obliquely incident from one of the imaging optical systems and the image of the object is focused onto a light receiving unit via the other imaging optical system so as to satisfy the following relationship:

(α−1)×(γ−1)>0

where β represents an absolute value of a magnification of the one imaging optical system, α×L₂ represents a distance from a principal point of the one imaging optical systems to the measurement region, γ/β represents an absolute value of a magnification of the other imaging optical system, L₂ represents a distance from a principal point of the other imaging optical system to the measurement region, and α and γ are positive real numbers.

Further features of the present invention will become apparent from the following description of exemplary embodiments with reference to the attached drawings.

### BRIEF DESCRIPTION OF THE DRAWINGS

FIG. 1 is a schematic view illustrating a layout in a focus measuring optical system according to a first embodiment of the present invention.

FIG. 2 is a schematic view illustrating a layout in a focus measuring optical system when the technique of the first embodiment is not applied.

FIG. 3 shows an optical layout of Case 2 in the first embodiment of the present invention.

FIG. 4 shows an optical layout of Case 3 in the first embodiment of the present invention.

FIG. 5 shows a shape of a focus measurement mark.

FIG. 6 illustrates a configuration of an EUV exposure apparatus.

FIG. 7 illustrates a second embodiment of the present invention.

FIG. 8 is a schematic view illustrating a third embodiment of the present invention.

FIG. 9 is a schematic view, as viewed from the +γ-direction in FIG. 8.

FIG. 10 illustrates a layout in a focus measuring optical system in an exposure apparatus.

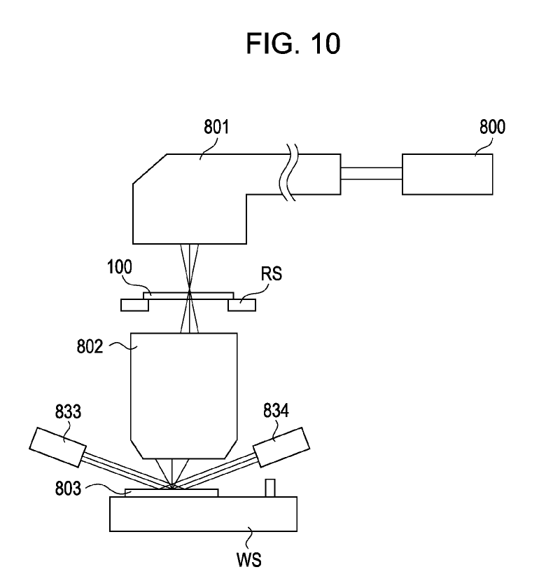

FIG. 11 explains the principle of focus measurement.

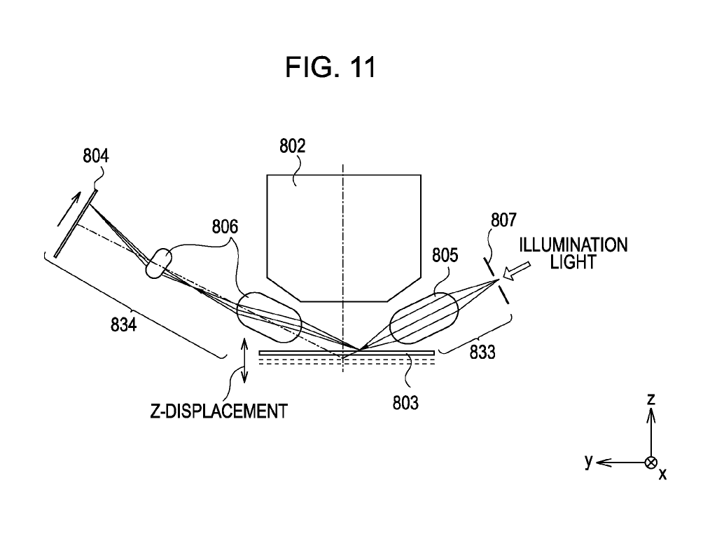

### DESCRIPTION OF THE EMBODIMENTS

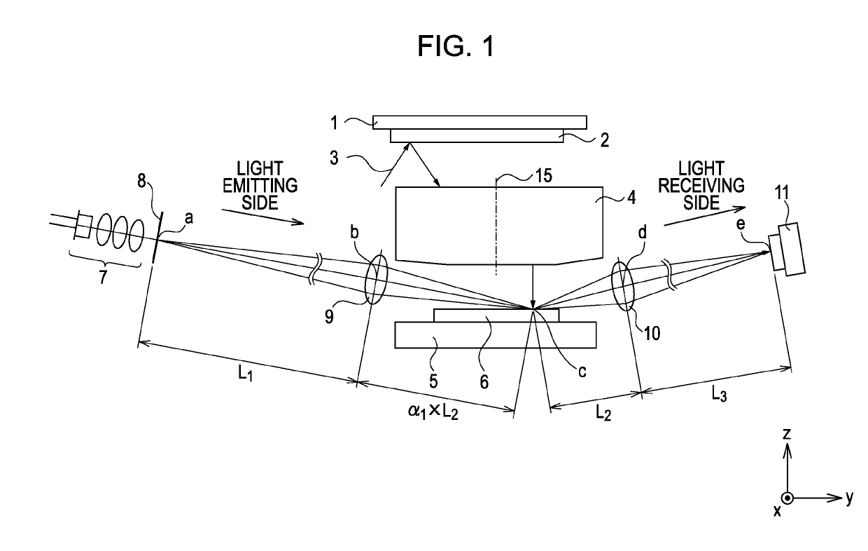

A first embodiment of the present invention will now be described with reference to FIGS. 1, 2, 5, and 6.

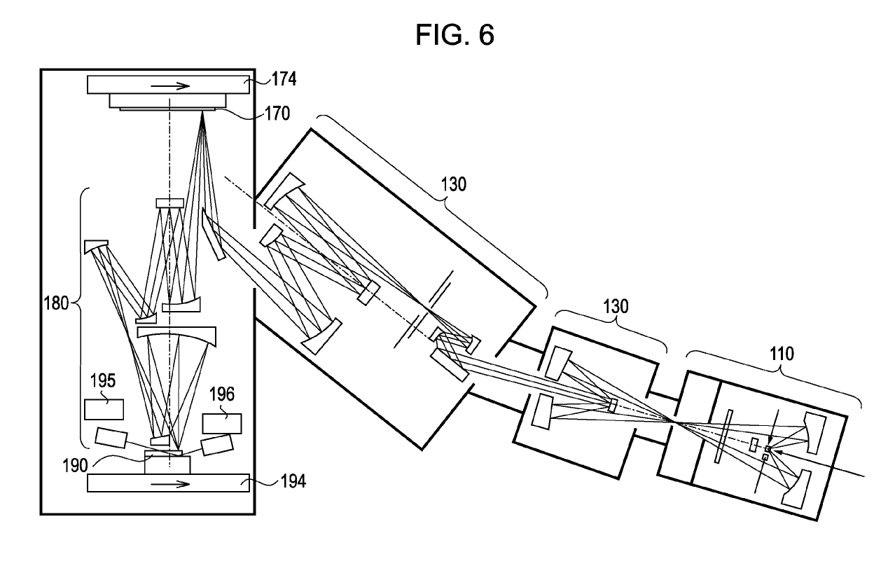

An exposure apparatus shown in FIG. 6 uses EUV light (having a wavelength of, for example, 13.5 nm) as illumination light for exposure. The exposure apparatus exposes and projects a circuit pattern on a retile 170 onto a wafer 190 in a reduced size by a step-and-repeat method or a step-and-scan method.

The transmittance of EUV light with respect to air is low, and EUV light generates contaminants by reaction with a residual gas (polymer organic gas) component. For this reason, at least an optical path of EUV light (that is, the entire optical system) is provided in a vacuum environment, as shown in FIG. 6. The exposure apparatus shown in FIG. 6 includes an EUV light source (light emitting device) 110, an illumination optical system 130, a reticle stage 174 on which a reticle 170 is placed, a projection optical system 180, and a wafer stage 194 on which a wafer 190 is placed. An exposure surface of the wafer 190 is measured in the height direction (Z-direction) with a focus measuring system (detecting unit) including a light emitting optical system 195 and a light receiving optical system 196.

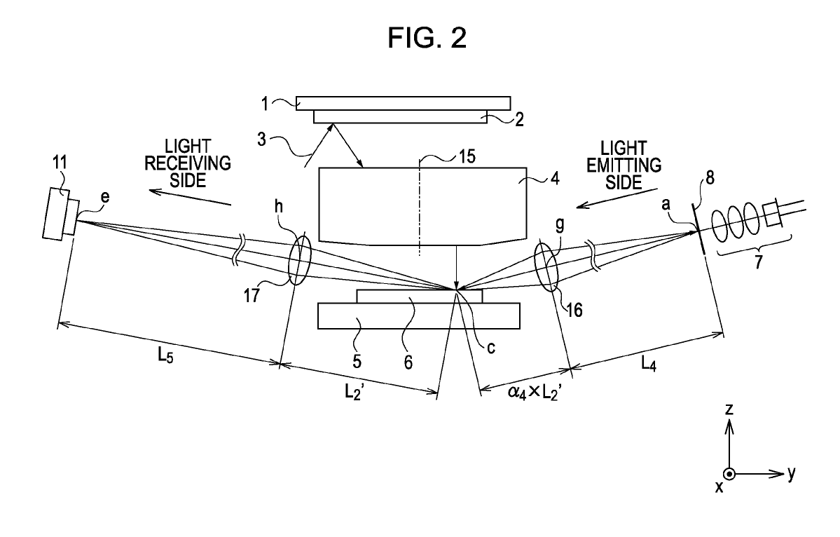

FIGS. 1 and 2 show layouts in the focus measuring system provided in the EUV exposure apparatus shown in FIG. 6. The present invention relates to a technique of shortening the total optical length of the focus measuring system (the length including the optical path lengths of the light emitting optical system and the light receiving optical system). For concise explanation, FIG. 1 shows the optical layout of the optical systems to which the present invention is applied, and FIG. 2 shows a case to which the present invention is not applied.

Referring to FIG. 1, EUV light 3 serving as exposure light obliquely enters and illuminates a reticle (original) 2 placed on a reticle stage 1. A pattern on the reticle 2 is projected in a reduced size onto a wafer (substrate) 6 placed on a wafer stage 5 via a reflective reduction projection optical system that is mounted in a barrel 4. The focus position of the wafer 6 at a focus measuring point c is measured in the following manner.

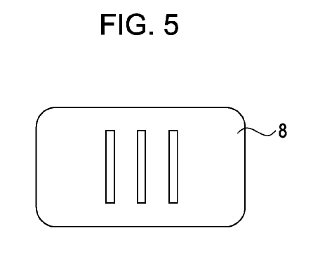

A wafer-height measurement mark 8 has a shape shown in FIG. 5. The wafer-height measurement mark 8 is illuminated by an illumination optical system 7, an image (object image) of the wafer-height measurement mark 8 is obliquely incident on the wafer 6 (substrate) via a light emitting optical system 9, and is focused on a surface of the wafer 6 (substrate surface). The projected image on the surface of the wafer 6 (on the substrate surface) is focused onto a detection surface e of a photoelectric converter 11 via a light receiving optical system 10. The position of center of gravity of the measurement mark 8 is detected from the focused image of the measurement mark. When the wafer 6 is displaced toward the focusing direction (Z-direction), the center of gravity of the measurement mark image is also displaced on the detection surface e of the photoelectric converter 11. By detecting the amount of displacement of the measurement mark image, focus measurement is performed. In the examples shown in FIGS. 1 and 2, one mark shown in FIG. 5 is obliquely projected onto the focus measuring point c, where focus measurement is performed. The measured focus position is a value measured in a range (measurement region) on which the wafer-height measurement mark 8 is projected. In such oblique incident focus measurement, when the exposure apparatus and the focus measuring system have the following relationship, the optical system can be made compact by application of the technique of the first embodiment of the present invention.

1. The barrel 4 that supports an optical component closest to the wafer in the reflective projection optical system is cut along a plane including the optical axis of the light emitting optical system in the oblique incident focus measuring system and the optical axis of the principal ray on the light receiving side. In the cross section (corresponding to FIG. 1 or 2), the focus measuring point c deviates from the center line 15 of the outer shape of the barrel 4. That is, the focus measuring point (measurement region) is provided at a position on the wafer and apart from the center axis of the barrel 4 in the projection optical system. Alternatively, a surface, which faces the wafer 6, of the barrel 4 that supports an optical component closest to the wafer 6 in the reflective projection optical system is cut along the above-described plane. Then, a perpendicular is drawn from the center of a line segment formed by the cut plane onto the wafer, and a focus measuring point is provided at a position apart from an intersection of the perpendicular and the wafer 6.

2. A space between the wafer 6 and a surface, which faces the wafer 6, of the barrel 4 that supports an optical component closest to the wafer 6 in the reflective projection optical system is narrow, and an optical component cannot be placed in the space.

It will be described below that the total optical path length of the focus measuring optical system changes, depending how to arrange the light emitting optical system (first imaging optical system) 9 and the light receiving optical system (second imaging optical system) 10 on the right and left side of the barrel 4 with respect to the focus measuring point c.

Optical systems that form the light emitting optical system 9 and the light receiving optical system 10 are expressed by the following image formation formulas.

First, symbols used in the formulas are defined as follows:
L₁: the distance from an object-side principal point b of the light emitting optical system 9 to a point a on the measurement mark 8
α₁×L₂: the distance from an image-side principal point b of the light emitting optical system 9 to the focus measuring point c (α₁ is a real number having a positive sign)
L₂: the distance from the focus measuring point c to an object-side principal point d of the light receiving optical system 10
L₃: the distance from an image-side principal point d of the light receiving optical system 10 to the detection surface e of the photoelectric converter 11
f₁: the focal length of the light emitting optical system 9
f₂: the focal length of the light receiving optical system 10
β: the imaging magnification (absolute value) of the light emitting optical system 9
γ₁/β: the imaging magnification (absolute value) of the light receiving optical system 10 (γ₁ is a real number having a positive sign)

The following image formation formulas (1) and (2) relate to the light emitting optical system 9:

$$\begin{matrix}\frac{1}{{L}_{1}} + \frac{1}{( {α}_{1} \times {L}_{2} )} = \frac{1}{{f}_{1}} & ( 1 ) \\ \frac{{α}_{1} \times {L}_{2}}{{L}_{1}} = β & ( 2 )\end{matrix}$$

The value of the imaging magnification β in Expression (2) is considered as follows. Depending on the configuration of the optical system, an erected image on an object plane including the point a in FIG. 1 is sometimes formed as an inverted image at an imaging position, or an erected image is sometimes formed as an erected image. When an erected image is formed as an inverted image, the imaging magnification is expressed by a value having a negative sign. When an erected image is formed as an erected image, the imaging magnification is expressed by a value having a positive sign. However, in the embodiment of the present invention, in the following expressions in which the optical path length of the optical system is expressed using β and γ₁/β, for example, in Expressions (5), (10), (11), (12), and (14) to (16), β and γ₁/β are defined as absolute values.

The following image formation formulas (3) and (4) relate to the light receiving optical system 10:

$$\begin{matrix}\frac{1}{{L}_{2}} + \frac{1}{{L}_{3}} = \frac{1}{{f}_{2}} & ( 3 ) \\ \frac{{L}_{3}}{{L}_{2}} = {γ}_{1} / β & ( 4 )\end{matrix}$$

The total optical length TL₁ of the focus measuring optical system shown in FIG. 1 (the distance obtained by linking the points a, b, c, d, and e in FIG. 1) is given using the relationships among Formulas (1) to (4):

$$\begin{matrix}{TL}_{1} = {L}_{1} + ( {α}_{1} {L}_{2} ) + {L}_{2} + {L}_{3} \\ = ( {α}_{1} / β ) {L}_{2} + {α}_{1} {L}_{2} + {L}_{2} + ( {γ}_{1} / β ) {L}_{2} \\ = {L}_{2} ( {α}_{1} / β + {α}_{1} + 1 + {γ}_{1} / β )\end{matrix} \qquad ( 5 )$$

Next, a description will be given of a procedure for finding the total optical path length TL₂ of the focus measuring optical system in the optical layout to which the present invention is not applied, as shown in FIG. 2. The focus measuring optical system shown in FIG. 2 is different from that in FIG. 1 in that the places of the light emitting optical system and the light receiving optical system respectively provided on the right and left sides of the barrel 4 change places with each other and in that the image distance of the light emitting optical system and the object distance of the light receiving optical system increase or decrease because of the change. The imaging magnifications of the light emitting optical system and the light receiving optical system are the same as those adopted in the case shown in FIG. 1.

The total optical path length of the light emitting optical system and the light receiving optical system in the layout shown in FIG. 2 is found, similarly to the layout in FIG. 1, and symbols used in formulas are defined as follows:
L₂: the distance from an object-side principal point g of a light emitting optical system 16 to a point a on a measurement mark 8
α₄×L₂′: the distance from an image-side principal point g of the light emitting optical system 16 to a focus measuring point c (α₄ is a real number having a positive sign)
L₂′: the distance from the focus measuring point c to an object-side principal point h of a light receiving optical system 17
L₅: the distance from an image-side principal point h of the light receiving optical system 17 to a detection surface e of a photoelectric converter 11
F₃: the focal length of the light emitting optical system 16
F₄: the focal length of the light receiving optical system 17
β: the imaging magnification (absolute value) of the light emitting optical system 16
γ₄/β: the imaging magnification (absolute value) of the light receiving optical system 17 (γ₄ is a real number having a positive sign)

The following image formation formulas (6) and (7) relate to the light emitting optical system 16:

$$\begin{matrix}\frac{1}{{L}_{4}} + \frac{1}{{α}_{4} \times {L}_{2}^{′}} = \frac{1}{{f}_{3}} & ( 6 ) \\ \frac{{α}_{4} \times {L}_{2}^{′}}{{L}_{4}} = β & ( 7 )\end{matrix}$$

The following image formation formulas (8) and (9) relate to the light receiving optical system 17:

$$\begin{matrix}\frac{1}{{L}_{2}^{′}} + \frac{1}{{L}_{5}} = \frac{1}{{f}_{4}} & ( 8 ) \\ \frac{{L}_{8}}{{L}_{2}^{′}} = {γ}_{4} / β & ( 9 )\end{matrix}$$

The total optical path length TL₂ of the focus measuring optical system in FIG. 2 is calculated using Formulas (6) to (9) as follows:

$$\begin{matrix}{TL}_{2} = {L}_{4} + {α}_{4} \times {L}_{2}^{′} + {L}_{2}^{′} + {L}_{5} \\ = ( {α}_{4} / β ) {L}_{2}^{′} + {α}_{4 \times } {L}_{2}^{′} + {L}_{2}^{′} + ( {γ}_{4} / β ) {L}_{2}^{′} \\ = {L}_{2}^{′} ( {α}_{4} / β + 1 + {α}_{4} + {γ}_{4} / β )\end{matrix} \qquad ( 10 )$$

The total optical lengths TL₁ and TL₂ of the optical systems shown in FIGS. 1 and 2 can be compared using concrete numerical values as follows.

Of the optical path lengths extending from the focus measuring point c below the barrel 4 to the right and left in FIG. 1, the optical path length between the points c and d is set at 10 cm, and the optical path length between the points c and b is set at 50 cm. On the other hand, the absolute value of the imaging magnification β of the light emitting optical system 9 in FIG. 1 is set at ½, and the imaging magnification γ₁/β of the light receiving optical system 10 is set at 12 (γ₁=6). In this case, the total optical path length TL₁ in FIG. 1 is given as follows:

$$\begin{matrix}{TL}_{1} = \overline{ab} + \overline{bc} + \overline{cd} + \overline{de} \\ = \frac{1}{β} \times \overline{bc} + \overline{bc} + \overline{cd} + \frac{{γ}_{1}}{β} \times \overline{cd} \\ = 2 \times 50 + 50 + 10 + 12 \times 10 \\ = 280 cm\end{matrix} \qquad ( 11 )$$

When the physical quantities in FIGS. 1 and 2 have a relationship such that α₁×L₂=L₂′ and L₂=α₄×L₂′, the distance between the points c and g is set at 10 cm, the distance between the points c and h is set at 50 cm in FIG. 2, and β and γ/β are equal to those in FIG. 1, the total optical length TL₂ in FIG. 2 is given as follows:

$$\begin{matrix}{TL}_{2} = \overline{ag} + \overline{gc} + \overline{ch} + \overline{he} \\ = \frac{1}{β} \times \overline{gc} + \overline{gc} + \overline{ch} + \frac{{γ}_{4}}{β} \times \overline{ch} \\ = 2 \times 10 + 10 + 50 + 12 \times 50 \\ = 680 cm\end{matrix} \qquad ( 12 )$$

As shown in the concrete examples of TL₁ and TL₂ given by Expressions (11) and (12), when the light emitting optical system and the light receiving optical system are arranged, as shown in FIG. 1, the optical path length is about 1/2.4 times of that of the optical layout shown in FIG. 2. This relationship can be given by the following general formula on the basis of the ratio γ of the imaging magnifications of the light emitting optical system and the light receiving optical system and the ratio α of the image distance of the light emitting optical system and the object distance of the light receiving optical system:

TL₂−TL₁>0 (13)

When Expressions (5) and (10) are substituted into Formula (13), (L₄+α₄×L₂′+L₂′+L₅)−(L₁+(α₁×L₂)+L₂+L₃)>0.

Assuming that α₁×L₂=L₂′ and L₂=α₄×L₂′, L₂(1/β+1+α₂+α₁γ₁/β)−L₂(α₁/β+α₁+1+γ₁/β)>0. This expression is rearranged into the following Conditional Expression (14) while α₁=α and γ₁=γ₄=γ:

1/β+αγ/β−α/β−γ/β>0 1+αγ−α−γ>0 (α−1)×(γ−1)>0 (α and γ are positive real numbers) (14)

In the imaging optical systems shown in FIGS. 1 and 2 each including the light emitting optical system and the light receiving optical system, as described above, the optical layout is set so that the ratio of the image magnification and the ratio of the optical path length of the specific portion satisfy Conditional Expression (14) (in this embodiment, the layout shown in FIG. 1 satisfies Conditional Expression (14)). In this case, it is possible to shorten the optical path length of the focus measuring optical system, and to increase the degree of flexibility in designing the other units that should be placed near the barrel.

Now, an optical system that satisfies Conditional Expression (14) and an optical system that does not satisfy Conditional Expression (14) will be described with reference to cases. First, an optical system satisfies Conditional Expression (14) in the following two cases:

α−1>0 and γ−1>0 →Case 1

α−1<0 and γ−1<0 →Case 2

An optical system does not satisfy Conditional Expression (14) in the following two cases:

α−1>0 and γ−1<0 →Case 3

α−1<0 and γ−1>0 →Case 4

The layouts of the optical systems in Cases 1 to 4 will be separately described below. As described above, α and γ are positive real numbers.

### Case 1:

The optical system in Case 1 corresponds to the optical system shown in FIG. 1. Here, α−1>0 means that α₁>1. This means that the image distance of the light emitting optical system (distance between the points b and c: α₁×L₂) is longer than the object distance of the light receiving optical system (distance between the points c and d: L₂). To distinguish from values α in the other cases, α used in Case 1 is designated as α₁. Hereinafter, numbers will be suffixed to α for distinction. On the other hand, γ−1>0 means that γ₁>1. This means that the absolute value of the imaging magnification γ₁/β of the light receiving optical system 10 is larger than the reciprocal of the absolute value of the imaging magnification β of the light emitting optical system 9 because γ₁>1. To distinguish from values γ in the other cases, γ used in Case 1 is designated as γ₁. Similarly to α, numbers will be suffixed to γ hereinafter.

### Case 4:

The optical system in Case 4 corresponds to the optical system shown in FIG. 2. The layout of the light emitting optical system and the light receiving optical system in FIG. 2 is the reverse of the layout shown in FIG. 1. Here, α−1<0 means that 1>α₄>0. This means that the image distance of the light emitting optical system (distance between the points c and g: α₄×L₂′) is shorter than the object distance of the light receiving optical system (distance between the points c and h: L₂′). Further, γ−1>0 means that γ₄>1, and this has a meaning similar to that of Case 1. In FIG. 2, the absolute value of the imaging magnification γ₄/β of the light receiving optical system 17 is larger than the reciprocal 1/β of the absolute value of the imaging magnification β of the light emitting optical system 16 because γ₄>1.

The comparison between the optical path lengths in Case 1 and Case 4 shows that the optical path length of the optical layout in Case 1, which satisfies Conditional Expression (14), is shorter, as in the specific examples given by Expressions (11) and (12). In such a case in which the object distance of the light receiving optical system is shorter than the image distance of the light emitting optical system and the absolute value of the imaging magnification of the light receiving optical system is larger than the reciprocal of the absolute value of the imaging magnification of the light emitting optical system, the total optical path length of the optical system can be made shorter by selecting the optical layout of Case 1.

Next, Case 2 and Case 3 will be described.

### Case 2:

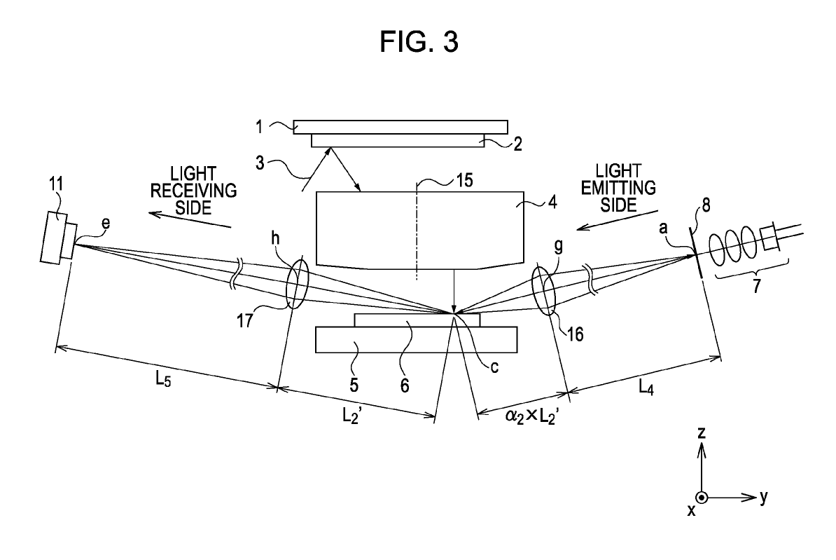

Case 2 corresponds to an optical layout shown in FIG. 3. Here, α−1<0 means that 1>α₂>0. This means that the image distance of a light emitting optical system (distance between points c and g: α₂×L₂′) is shorter than the object distance of a light receiving optical system (distance between points c and h: L₂′). Further, γ−1<0 means that 1>γ₂>0, and this means that the absolute value of the imaging magnification γ₂/β of the light receiving optical system is smaller than the reciprocal 1/β of the absolute value of the imaging magnification β of the light emitting optical system because 1>γ₂>0.

### Case 3:

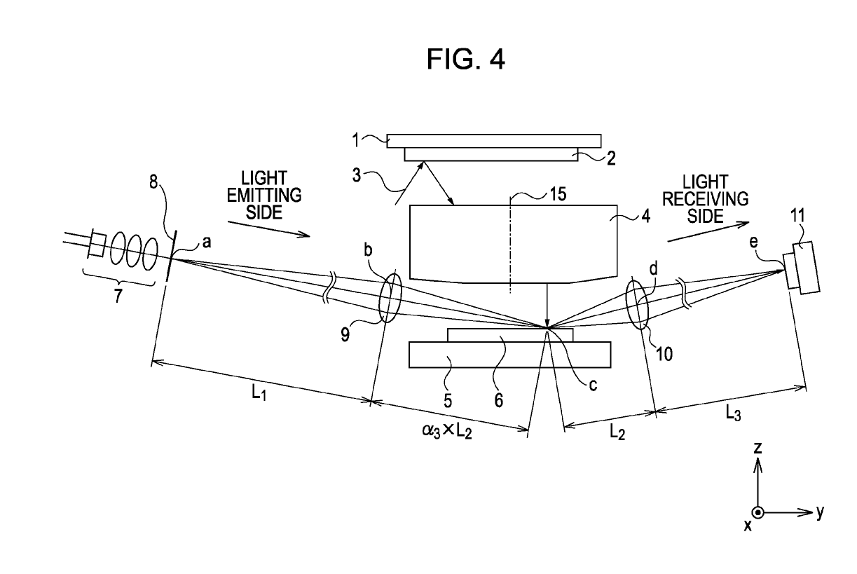

Case 3 corresponds to an optical layout shown in FIG. 4. The layout of the light emitting optical system and the light receiving optical system in FIG. 4 is the reverse of the layout shown in FIG. 3. Here, α−1>0 means that α₃>1. This means that the image distance of a light emitting optical system (distance between points b and c: α₃×L₂) is longer than the object distance of a light receiving optical system (distance between points c and d: L₂). Further, γ−1<0 means that 1>γ₃>0, and this means that the absolute value of the imaging magnification γ₃/β of the light receiving optical system is smaller than the reciprocal 1/β of the absolute value of the imaging magnification β of the light emitting optical system because 1>γ₃>0.

The optical path lengths in Case 2 and Case 3 will be described with concrete examples. Here, L₂′=α₃×L₂ and α₂×L₂′=L₂, and the absolute values of the imaging magnifications of the light emitting optical system and the light receiving optical system are the same as those in FIGS. 3 and 4. When the object distance of the light receiving optical system (distance between points c and h) is 50 cm, the image distance of the light emitting optical system (distance between points c and g) is 10 cm (α₂=⅕), the imaging magnification (absolute value) of the light emitting optical system is ½, and the imaging magnification (absolute value) of the light receiving optical system is 1.2 (γ₂=0.6), the total optical path length TL₃ (point a-g-c-h-e) of the light emitting optical system and the light receiving optical system in FIG. 3 is given by the following Expression (15):

$$\begin{matrix}{TL}_{3} = {L}_{4} + {α}_{2} \times {L}_{2}^{′} + {L}_{2}^{′} + {L}_{5} \\ = 20 + 10 + 50 + 60 \\ = 140 cm\end{matrix} \qquad ( 15 )$$

In Case 3 shown in FIG. 4, when the object distance of the light receiving optical system (distance between points c and d) is 10 cm, the image distance of the light emitting optical system (distance between points c and b) is 50 cm (α₃=5), the imaging magnification (absolute value) of the light emitting optical system is ½, and the imaging magnification (absolute value) of the light receiving optical system is 1.2 (γ₃=0.6), the total optical path length TL₄ (point a-b-c-d-e) of the light emitting optical system and the light receiving optical system in FIG. 4 is given by the following Expression (16):

$$\begin{matrix}{TL}_{4} = {L}_{1} + {α}_{3} \times {L}_{2} + {L}_{2} + {L}_{3} \\ = 100 + 50 + 10 + 12 \\ = 172 cm\end{matrix} \qquad ( 16 )$$

This shows that the total optical path length in Case 2, which satisfies Conditional Expression (14), is shorter.

As described above, the optical path length in the optical layout of Case 1 which satisfies Conditional Expression (14) is shorter than in the optical layout of Case 4 in which the layout of the light emitting optical system and the light receiving optical system is reversed and which does not satisfy Conditional Expression 14. Similarly, the optical path length in Case 2 that satisfies Conditional Expression (14) is shorter than in Case 3.

In comparison between the absolute value γ/β of the imaging magnification of the light receiving optical system and the reciprocal (=1/β) of the absolute value of the imaging magnification of the light emitting optical system, the effect of shortening the optical path length in this embodiment increases when γ>1 and as γ increases.

For concise explanation, the light emitting optical systems and the light receiving optical systems are each shown as a single thin lens in FIGS. 1 to 4, and the object-side principal point and the image-side principal point are provided at the same position in each optical system. In general, a light emitting optical system and a light receiving optical system in a focus measuring system in an exposure apparatus each include a plurality of lenses. In FIGS. 1 to 4, the representative principal point in the entire light emitting optical system or the representative principal point of a block of the light emitting optical system corresponds to the principal point in the first embodiment. When the object-side principal point and the image-side principal point do not coincide, the distances from the principal points to a predetermined position are calculated according to Expressions (1) to (14). This also applies to the light receiving optical system.

By thus designing the optical systems in the focus measuring system, a more compact optical system can be provided. Accordingly, for example, even when the focus measuring system is placed near the barrel in the exposure apparatus, it does not occupy a lot of space near the barrel. This can contribute to reduction of the footprint of the entire exposure apparatus.

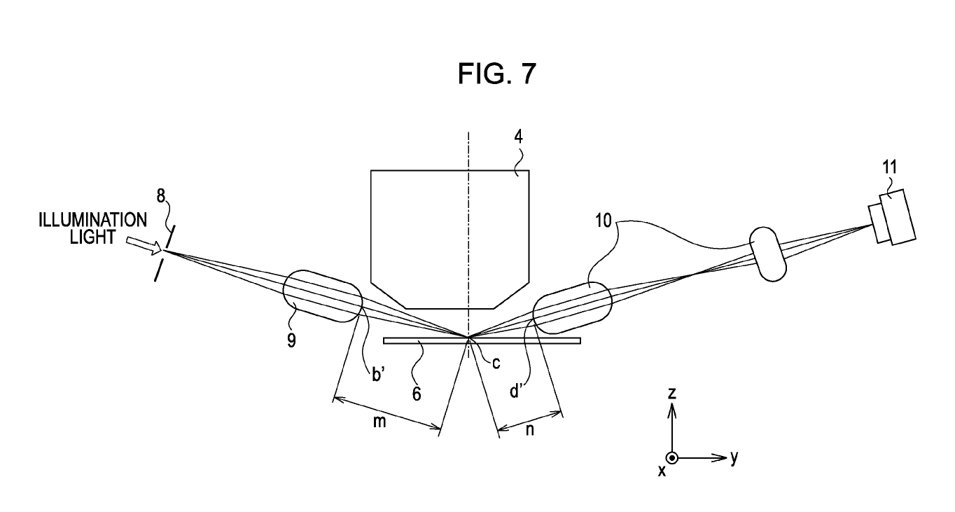

FIG. 7 shows a focus measuring optical system according to a second embodiment. In the focus measuring optical system, a light emitting optical system (first imaging optical system) 9 projects a measurement mark 8 onto a surface of a wafer 6 in a reduced size. On the other hand, a light receiving optical system (second imaging optical system) 10 focuses the image of the measurement mark 8 projected on the wafer 6 onto a detection surface of a photoelectric converter 11 in an enlarged size.

For example, in the EUV exposure apparatus using EUV light as exposure light, as shown in FIG. 1, there is only a small gap between the wafer 6 and the surface of the barrel 4 in the reflective projection optical system closest to the wafer 6. For this reason, it is quite difficult to place a part of an optical element of the focus measuring optical system in this gap. Here, the term “optical element” refers to a lens, a parallel plate, or a prism formed of optical glass. Assuming that m represents the distance from the focus measuring position c to a point b′ on the optical axis of the final surface of the light emitting optical system 9 and n represents the distance from the focus measuring position c to a point d′ on the optical axis of the first surface of the light receiving optical system 10, the total optical path length of the optical system can be made shorter when m>n than when m<n. Herein, the final surface of the light projecting optical system 9 refers to a surface of an optical component closest to an image plane of the light emitting optical system 9, and the image plane of the light emitting optical system 9 refers to a plane that is perpendicular to the optical axis of the light emitting optical system 9 and that includes the focus measuring point c. Further, the first surface d′ of the light receiving optical system 10 refers to a surface of an optical component closest to an object plane of the light receiving optical system 10, and the object plane of the light receiving optical system 10 refers to a plane that is perpendicular to the optical system of the light receiving optical system 10 and that includes the focus measuring point c.

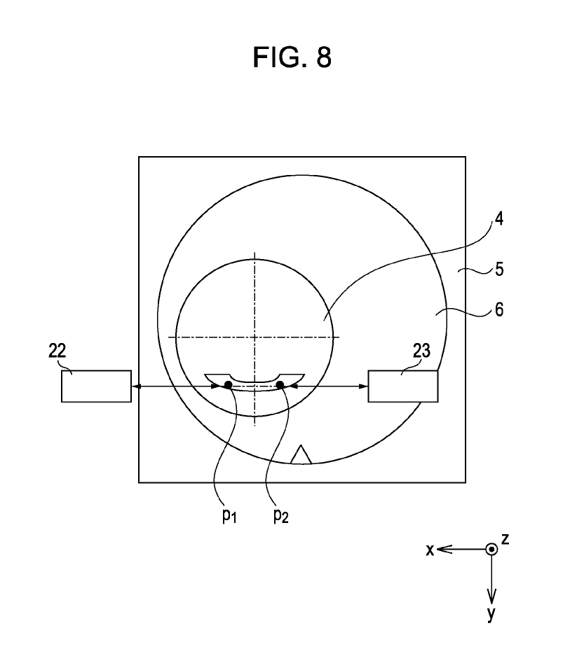

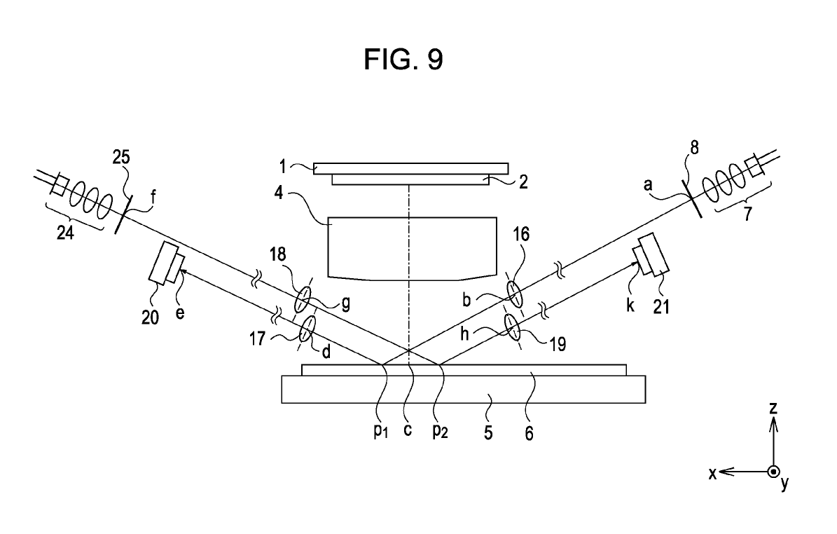

A third embodiment of the present invention will now be described with reference to FIGS. 8 and 9. First, the configuration of the first embodiment will be described with reference to FIG. 8 in order to show differences between the first and third embodiment. In the first embodiment, measuring light is applied from a position parallel to the scanning direction y of the wafer 6 placed on the wafer stage 5 toward a measuring point p₁ or p₂ on the wafer 6 by the light emitting optical system, and reflected light from the wafer 6 is received by the light receiving optical system. In contrast, in the third embodiment, a light emitting optical system 22 and a light receiving optical system 23 (places of the light emitting optical system 22 and the light receiving optical system 23 may be changed) are arranged parallel to the x-axis. Since the arrangement of the light emitting optical system 22 and the light receiving optical system 23 with respect to the wafer scanning direction is illustrated in FIG. 8, detailed optical layouts of the light emitting optical system 22 and the light receiving optical system 23 is not shown in the figure. Further, the positions of the light emitting optical system and the light receiving optical system may be turned by ωz with respect to the optical axis parallel to the y-axis or the x-axis.

FIG. 9 is a view of the apparatus, as viewed from the +y-direction in FIG. 8 serving as a schematic view. It is assumed that, when an intersection of the center of a barrel of a light emitting optical system 4 and the wafer 6 is designated as c, a focus measuring point p₁ is at a position offset from the point c. The height of the wafer is measured at the point p₁ in the following manner. Illumination light emitted from a light source 7 illuminates a measurement mark 8, and an image of the measurement mark 8 is projected onto the point p₁ on the wafer 6 by a light emitting optical system 16. The projected image of the measurement mark 8 reflected at the point p₁ is focused onto a light receiving surface e of a CCD 20 by a light receiving optical system 17. The optical path length (point a-b-p1-d-e) of the focus measuring optical system can be shortened by setting α and γ so as to satisfy Conditional Expression (14) described in the first embodiment. Here, symbols are set as follows:
α×L₂: the distance from an image-side principal point b of the light emitting optical system 16 to the point p₁
L₁: the distance from an object-side principal point b of the light emitting optical system 16 to a point a
L₂: the distance from an object-side principal point d of the light receiving optical system 17 to the point p₁
L₃: the distance from an image-side principal point d of the light receiving optical system 17 to the point e
β: the imaging magnification (absolute value) of the light emitting optical system 16
γ/β: the imaging magnification (absolute value) of the light receiving optical system 17

The height of the wafer is measured at a measuring point p₂ offset from the point c to the right in the following manner. Illumination light emitted from a light source 24 illuminates a measurement mark 25, and an image of the measurement mark 25 is projected onto the point p₂ on the wafer 6 by a light emitting optical system 18. The projected image of the measurement mark 25 reflected at the point p₂ is focused onto a light receiving surface k of a CCD 21 by a light receiving optical system 19. Thus, the optical path length (point f-g-p₂-h-k) of the focus measuring optical system can be shortened by setting α and γ so as to satisfy Conditional Expression (14) described in the first embodiment. Here, symbols are set as follows:
α×L₂: the distance from an image-side principal point g of a light emitting optical system 18 to the point p₂
L₁: the distance from an object-side principal point g of the light emitting optical system 18 to a point f
L₂: the distance from an object-side principal point h of a light receiving optical system 19 to the point p₂
L₃: the distance from an image-side principal point h of the light receiving optical system 19 to a point k
β: the imaging magnification (absolute value) of the light emitting optical system 18
γ/β: the imaging magnification (absolute value) of the light receiving optical system 19

In the third embodiment, while the positions of the light emitting and receiving optical systems in the focus measuring optical system are in a reversed relation between the measurements at the points p₁ and p₂, illumination light may be incident from the same direction in both cases as long as Conditional Expression (14) is satisfied.

A device manufacturing method will now be described. A device (e.g., a semiconductor integrated circuit element or a liquid crystal display element) is manufactured through a step of exposing a substrate (e.g., a wafer or a glass substrate) coated with photosensitive material with the exposure apparatus according to any of the above-described embodiments, a step of developing the substrate, and other known steps.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

This application claims the benefit of Japanese Patent Application No. 2008-175916 filed Jul. 4, 2008, which is hereby incorporated by reference herein in its entirety.

1. An optical system provided in a detection unit of an exposure apparatus that projects a pattern of an original onto a substrate via a projection optical system, the detection unit detecting a position of the substrate in an optical axis direction of the projection optical system,
wherein the optical system comprises:
a first imaging optical system configured to form an image of an object in a measurement region of the substrate by oblique light incidence; and
a second imaging optical system configured to focus the image onto a light receiving unit, and
wherein the following relationship is satisfied:
(α−1)×(γ−1)>0
where α represents a ratio of the image distance of the first imaging optical system and the object distance of the second imaging optical system, γ represents a ratio of the imaging magnifications of the first imaging optical system and the second imaging optical system, and α and γ are positive real numbers.

2. The optical system according to claim 1, wherein the following condition is satisfied:
m>n
where m represents a distance from a point on a surface of an optical component of the first imaging optical system closest to an image side on the optical axis, to an intersection of the optical axis of the first imaging optical system and the substrate, and n represents a distance from a point of a surface of an optical component of the second imaging optical system closest to an object side on the optical axis, to an intersection of the optical axis of the second imaging optical system and the substrate.

3. The optical system according to claim 1, wherein the exposure apparatus projects the pattern of the original onto the substrate by exposure to EUV light.

4. An optical system provided in a detection unit of an exposure apparatus that projects a pattern of an original onto a substrate via a projection optical system, the detection unit detecting a position of a measurement region in an optical axis direction of the projection optical system,
wherein the optical system comprises:
a first imaging optical system configured to form an image of an object in the measurement region of the substrate by oblique light incidence; and
a second imaging optical system configured to focus the image of the object onto a light receiving unit, and
wherein the following relationship is satisfied:
(α−1)×(γ−1)>0
where α represents a ratio of the image distance of the first imaging optical system and the object distance of the second imaging optical system, γ represents a ratio of the imaging magnifications of the first imaging optical system and the second imaging optical system, and α and γ are positive real numbers.

5. An optical system provided in a detection unit of an exposure apparatus that projects a pattern of an original onto a substrate via a projection optical system, the detection unit detecting a position of a measurement region in an optical axis direction of the projection optical system,
wherein the optical system comprises two imaging optical systems, and
wherein an image of an object is formed in the measurement region by causing light to be obliquely incident from one of the imaging optical systems and the image of the object is focused onto a light receiving unit via the other imaging optical system so as to satisfy the following relationship:
(α−1)×(γ−1)>0
where α represents a ratio of the image distance of the former imaging optical system and the object distance of the latter imaging optical system, γ represents a ratio of the imaging magnifications of the former imaging optical system and the latter imaging optical system and α and γ are positive real numbers.

6. An exposure apparatus that projects a pattern of an original onto a substrate, comprising:
a projection optical system; and
a detection unit configured to detect a position of the substrate in an optical axis direction of the projection optical system, and including an optical system,
wherein the optical system includes:
a first imaging optical system configured to form an image of an object in a measurement region of the substrate by oblique light incidence; and
a second imaging optical system configured to focus the image of the object formed on the surface of the substrate by the first imaging optical system onto a light receiving unit, and
wherein the following relationship is satisfied:
(α−1)×(γ−1)>0
where α represents a ratio of the image distance of the first imaging optical system and the object distance of the second imaging optical system, γ represents a ratio of the imaging magnifications of the first imaging optical system and the second imaging optical system, and α and γ are positive real numbers.

7. An exposure apparatus that projects a pattern of an original onto a substrate, comprising:
a projection optical system; and
a detection unit configured to detect a position of the substrate in an optical axis direction of the projection optical system, and including an optical system,
wherein the optical system includes:
a first imaging optical system configured to form an image of an object in a measurement region by oblique light incidence; and
a second imaging optical system configured to focus the image onto a light receiving unit, and
wherein the following relationship is satisfied:
(α−1)×(γ−1)>0
where α represents a ratio of the image distance of the first imaging optical system and the object distance of the second imaging optical system, γ represents a ratio of the imaging magnifications of the first imaging optical system and the second imaging optical system, and α and γ are positive real numbers.

8. An exposure apparatus that projects a pattern of an original onto a substrate, comprising:
a projection optical system; and
a detection unit configured to detect a position of the substrate in an optical axis direction of the projection optical system, and including an optical system,
wherein the optical system includes two imaging optical systems, and
wherein an image of an object is formed in a measurement region by causing light to be obliquely incident from one of the imaging optical systems and the image of the object is focused onto a light receiving unit via the other imaging optical system so as to satisfy the following relationship:
(α−1)×(γ−1)>0
where α represents a ratio of the image distance of the former imaging optical system and the object distance of the latter imaging optical system and γ represents a ratio of the imaging magnifications of the former imaging optical system and the latter imaging optical system, and α and γ are positive real numbers.

9. A device manufacturing method comprising:
exposing a substrate with an exposure apparatus; and
developing the exposed substrate,
wherein the exposure apparatus includes:
a projection optical system; and
a detection unit configured to detect a position of the substrate in an optical axis direction of the projection optical system, and including an optical system,
wherein the optical system includes:
a first imaging optical system configured to form an image of an object in a measurement region of the substrate by oblique light incidence; and
a second imaging optical system configured to focus the image of the object onto a light receiving unit, and
wherein the following relationship is satisfied:
(α−1)×(γ−1)>0
where α represents a ratio of the image distance of the first imaging optical system and the object distance of the second imaging optical system, γ represents a ratio of the imaging magnifications of the first imaging optical system and the second imaging optical system, and α and γ are positive real numbers.

10. A device manufacturing method comprising:
exposing a substrate with an exposure apparatus; and
developing the exposed substrate,
wherein the exposure apparatus includes:
a projection optical system; and
a detection unit configured to detect a position of the substrate in an optical axis direction of the projection optical system, and including an optical system,
wherein the optical system includes:
a first imaging optical system configured to form an image of an object in a measurement region of the substrate by oblique light incidence; and
a second imaging optical system configured to focus the image of the object formed on the surface of the substrate by the first imaging optical system onto a light receiving unit, and
wherein the following relationship is satisfied:
(α−1)×(γ−1)>0
where α represents a ratio of the image distance of the first imaging optical system and the object distance of the second imaging optical system, γ represents a ratio of the imaging magnifications of the first imaging optical system and the second imaging optical system, and α and γ are positive real numbers.

11. A device manufacturing method comprising:
exposing a substrate with an exposure apparatus; and
developing the exposed substrate,
wherein the exposure apparatus includes:
a projection optical system; and
a detection unit configured to detect a position of the substrate in an optical axis direction of the projection optical system, and including an optical system,
wherein the optical system includes two imaging optical systems, and
wherein an image of an object is formed in a measurement region by causing light to be obliquely incident from one of the imaging optical systems and the image of the object is focused onto a light receiving unit via the other imaging optical system so as to satisfy the following relationship:
(α−1)×(γ−1)>0
where α represents a ratio of the image distance of the former imaging optical system and the object distance of the latter imaging optical system, γ represents a ratio of the imaging magnifications of the former imaging optical system and the latter imaging optical system, and α and γ are positive real numbers.
